(19) United States
(12) Patent Application Publication
(10) Pub. No.: US 2008/0316755 A1
(43) Pub. Date: Dec. 25, 2008

(54) LED LAMP HAVING HEAT DISSIPATION STRUCTURE

(75) Inventors: SHI-SONG ZHENG, Shenzhen (CN); GUANG YU, Shenzhen (CN); LI HE, Shenzhen (CN); WEN-XIANG ZHANG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 11/875,149

(22) Filed: Oct. 19, 2007

(30) Foreign Application Priority Data
Jun. 22, 2007 (CN) 200710075196.0

(51) Int. Cl. F21V 29/00

(52) U.S. Cl. 362/373

(57) ABSTRACT

An LED lamp includes a lamp base, a heat sink and a plurality of LED modules. The lamp base includes a lamp holder and an enclosure connecting with the lamp holder. The enclosure defines a plurality of vents therein. The heat sink is mounted on the lamp base and includes a cylinder at a centre thereof and a plurality of fins surrounding the cylinder. The cylinder has a through hole therein, which communicates with the enclosure. The through hole, the enclosure and the vents cooperatively form an air circulation passage communicating with ambient air. The LED modules are mounted on outmost ones of the fins of the heat sink, respectively.

### BACKGROUND OF THE INVENTION

1. Field of the Invention

The present invention relates to an LED lamp, and particularly to an LED lamp having a heat dissipation structure for dissipating heat from LEDs of the LED lamp.

2. Description of Related Art

An LED lamp is a type of solid-state lighting that utilizes light-emitting diodes (LEDs) as a source of illumination. An LED is a device for transferring electricity to light by using a theory that, if a current is made to flow in a forward direction through a junction region comprising two different semiconductors, electrons and cavities are coupled at the junction region to generate a light beam. The LED has an advantage that it is resistant to shock and has an almost eternal lifetime under a specific condition; thus, the LED lamp is intended to be a cost-effective yet high quality replacement for incandescent and fluorescent lamps.

An LED lamp generally requires a plurality of LEDs, and most of the LEDs are driven at the same time, which results in a quick rise in temperature of the LED lamp. Since generally the LED lamps do not have heat dissipation devices with good heat dissipating efficiencies, operation of the conventional LED lamps has a problem of instability because of the rapid increase of heat. Consequently, the light from the LED lamp often flickers, which degrades the quality of the illumination. Furthermore, the LED lamp is used in a state of high temperature for a long time, whereby the life time thereof is consequently shortened.

What is needed, therefore, is an LED lamp which has a heat dissipation structure with a great heat dissipating capability. Furthermore, the heat dissipation structure has a compact design, whereby the LED lamp has a dimension which is suitable for indoor use.

### SUMMARY OF THE INVENTION

An LED lamp for lighting includes a lamp base, a heat sink and a plurality of LED modules. The lamp base includes a lamp holder and an enclosure connecting with the lamp holder. The enclosure defines a plurality of vents therein. The heat sink is mounted on the lamp base and includes a cylinder at a centre thereof and a plurality of second fins surrounding the cylinder. The cylinder has a through hole therein, which communicates with the enclosure. The through hole, the enclosure and the vents cooperatively form an air circulation passage communicating with ambient air. The cylinder forms a plurality of first fins extending into the through hole. The LED modules contact respectively with outmost ones of the second fins of the heat sink.

### BRIEF DESCRIPTION OF THE DRAWINGS

Many aspects of the present LED lamp can be better understood with reference to the following drawings. The components in the drawings are not necessarily drawn to scale, the emphasis instead being placed upon clearly illustrating the principles of the present LED lamp. Moreover, in the drawings, like reference numerals designate corresponding parts throughout the several views.

FIG. 1 is an isometric, assembled view of an LED lamp in accordance with a preferred embodiment of the present invention;

FIG. 2 is an isometric, exploded view of FIG. 1; and

FIG. 3 is an isometric view of a heat sink of the LED lamp of FIG. 1.

### DETAILED DESCRIPTION OF THE INVENTION

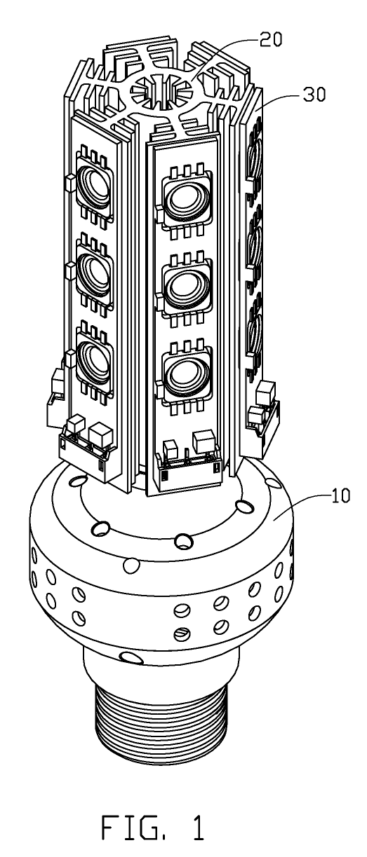

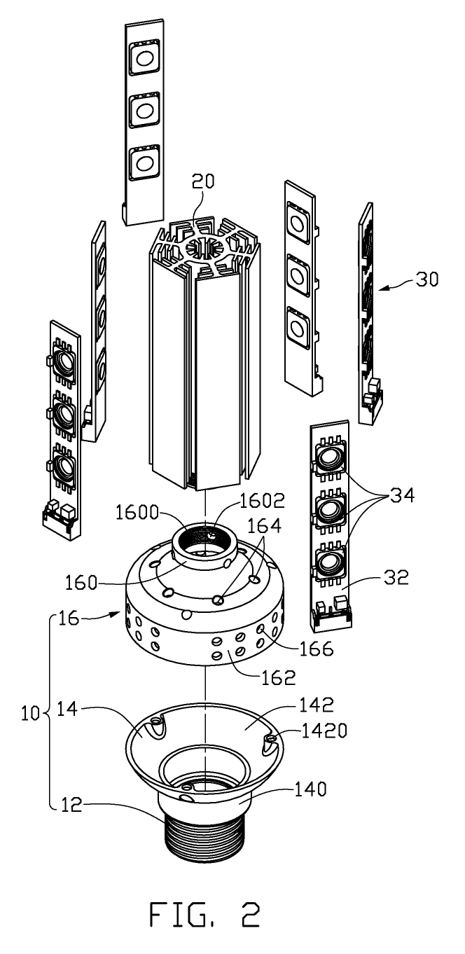

Referring to FIGS. 1-2, an LED lamp for a lighting purpose comprises a lamp base 10, a heat sink 20 coupled to the lamp base 10 and a plurality of LED modules 30 thermally attached to a periphery of the heat sink 30.

The lamp base 10 comprises a lamp holder 12, a first cover 14 connecting with the lamp holder 12 and a second cover 16 facing to and engaging with the first cover 14. The lamp holder 12 has screw threads formed on a periphery thereof and has a standardized configuration for fitting in a standardized lamp socket (not shown). The first cover 14 comprises an annular joining portion 140 coupled with the lamp holder 12 and a first bowl-shaped body 142 extending upwardly from an upper edge of the joining portion 140. The first bowl-shaped body 142 has a caliber increasing gradually from a bottom to a top thereof. Three fixing orifices 1420 are evenly defined in an upper rim of the first bowl-shaped body 142. The three fixing orifices 1420 extend through the first bowl-shaped body 142 vertically for allowing screws passing therethrough to screw into the second cover 16.

The second cover 16 comprises an annular engaging portion 160 at a top thereof and a second bowl-shaped body 162 extending downwardly from a lower edge of the engaging portion 160. The engaging portion 160 has a diameter smaller than that of the joining portion 140 of the first cover 14 and forms screw threads 1600 in an inner wall thereof for engaging with the heat sink 20. Three through orifices 1602 are evenly defined in annular wall of the engaging portion 160 along a circumferential direction of the engaging portion 160. An upper portion of the second bowl-shaped body 162 has a caliber increasing gradually from a top to a bottom thereof and defines a plurality of leading orifices 164 therein for allowing lead wires (not shown) to extend from an inner space (not labeled) of the lamp base 10 through the leading orifices 164 to electrically connect with the LED modules 30. A lower portion of the bowl-shaped body 162 which has a constant caliber is substantially tube-shaped and symmetrically defines a plurality of vents 166 for allowing ambient air to flow into the inner space enclosed by the first and second covers 14, 16 of the lamp base 10 and circulate in the LED lamp. Three engaging orifices (not shown) are symmetrically defined in a lower rim of the second bowl-shaped body 162. The three engaging orifices are used for engaging with the screws extending through the fixing orifices 1420 of the first cover 14 to couple the first cover 14 with the second cover 16. The first and second covers 14, 16 cooperatively form an enclosure defining the inner space therein. A rectifier (not shown) for the LED modules 30 can be accommodated in the inner space of the enclosure.

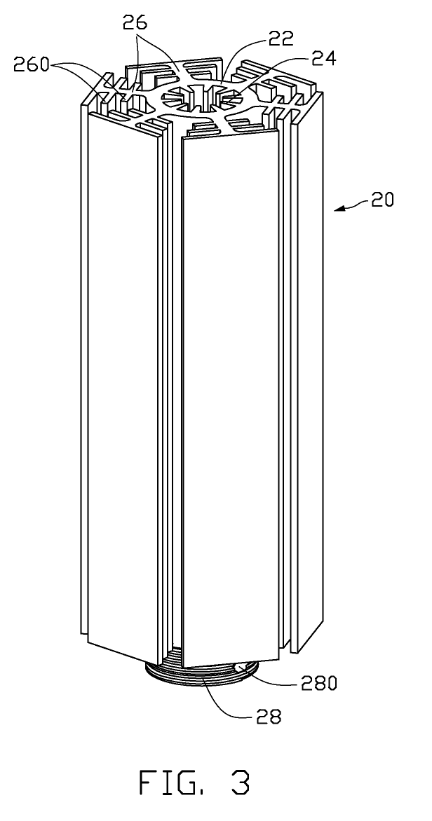

As shown in FIG. 3, the heat sink 20 is integrally made of a metal with a good heat conductivity, such as aluminum, copper or an alloy thereof. The heat sink 20 has a heat-conductive member at a centre thereof. In this embodiment, the heat-conductive member is an elongated cylinder 22 with a through hole (not labeled) defined therein. The cylinder 22 has a plurality of first fins 24 extending inwardly from an inner wall thereof. The first fins 24 are centrosymmetric relative to a central axis of the cylinder 22 and each have a thickness decreasing inwardly. The heat sink 20 has a plurality of conducting arms 26 extending outwardly from an outer wall of the cylinder 22. The conducting arms 26 are identical to each other and centrosymmetric relative to the central axis of the cylinder 22. The conducting arms 26 have a number which is corresponding to that of the LED modules 30; the number can be different in different embodiments. In this embodiment, the numbers of the conducting arms 26 and the LED modules 30 are both six. A plural pairs of second fins 260 are formed on two opposite lateral sides of each of the conducting arms 26. Each pair of the second fins 260 extend respectively and perpendicularly from two lateral sides of a corresponding conducting arm 26 and are symmetrical to each other in respect to the corresponding conducting arm 26. The second fins 260 at a lateral side of each of the conducting arms 26 increase in length outwardly from the cylinder 22 to a distal end of the corresponding conducting arm 26. Each of the conducting arms 26 has a distal end terminating at an inner face of an outmost second fin 260 thereof. An outer face (not labeled) of each outmost second fin 260 is flat and used for thermally contacting with one of the LED modules 30, when the LED module 30 is mounted on the outer face.

An annular fixing part 28 extends downwardly and vertically from a bottom edge of the cylinder 22 and forms screw thread thereon for screwing into the engaging portion 160 of the second cover 16 to mount the heat sink 20 on the lamp base 10. The fixing part 28 symmetrically defines three through orifices 280 therein corresponding to the through orifices 1602 of the engaging portion 160 of the second cover 16. The heat sink 20 can be further locked together with the lamp base 10 by three bolts (not shown) inserting into the corresponding through orifices 1602, 280 when the fixing part 28 of the heat sink 20 is received in the engaging portion 160 of the second cover 16 at a predetermined position.

Also referring to FIG. 2, the LED modules 30 each comprise an elongated printed circuit board 32 with a size slightly smaller than that of the outmost second fin 260 of the heat sink 20. A plurality of LED components 34 (three in this embodiment) are mounted in a line on each of the printed circuit boards 32 along a length of the printed circuit board 32.

In assembly of the LED lamp, the screws pass through the fixing orifices 1420 of the first cover 14 of the lamp base 10 to screw into the second cover 16 of the lamp base 10; the first and second covers 14, 16 are thus assembled together. The heat sink 20 is mounted to the second cover 16 of the lamp base 10 by the fixing part 28 at the bottom of the heat sink 16 screwing downwardly into the engaging portion 160 of the second cover 16. The LED modules 30 are respectively attached to the outer faces of the outermost second fins 260 of the heat sink 20 in a thermal conductive relationship therewith.

In use of the LED lamp, the enclosure formed by the first and second covers 14, 16 and the through hole in the cylinder 22 of the heat sink 20 communicate with each other and cooperate to form an air passage in the LED lamp. Ambient air can flow into the air passage in the LED lamp through the vents 166 of the first cover 14 of the LED base 10 and exit the air passage from a top of the cylinder 22 of the heat sink 20. Alternatively, ambient air can enter the air passage through the top of the cylinder 22 and exit therefrom from the vents 166. An air circulation is thus formed wherein air circulates between the air passage in the LED lamp and ambient around the LED lamp. When the LED modules 30 are activated, heat generated by the LED components 34 is absorbed by the outmost second fins 260 of the heat sink 20 and then evenly distributed to the whole heat sink 20 via the conducting arms 26 of the heat sink 20. The heat of the heat sink 20 is finally removed by airflow circulating in the air passage and ambient air.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED lamp comprising:
a lamp base defining a plurality of vents therein;
a heat sink comprising a cylinder at a centre thereof, the cylinder having a through hole defined therein, which communicates with the vents of the lamp base and cooperates with the vents to form an air passage communicating with ambient air; and
a plurality of the LED modules attached to a periphery of the heat sink.

2. The LED lamp of claim 1, wherein the cylinder has a plurality of first fins extending inwardly from an inner wall thereof and a plurality of second fins surrounding the cylinder.

3. The LED lamp of claim 2, wherein a thickness of each of the first fins decreases inwardly.

4. The LED lamp of claim 1, wherein the heat sink has a plurality of conducting arms extending outwardly from an outer wall of the cylinder, and the conducting arms are centrosymmetric relative to a central axis of the cylinder.

5. The LED lamp of claim 4, wherein second fins are formed at two lateral sides of each of the conducting arms.

6. The LED lamp of claim 5, wherein the second fins of the each of the conducting arms are perpendicular and symmetrical to each other in respect to the each of the conducting arms, and the second fins at a lateral side of the each of the conducting arms increase in length outwardly from the cylinder to a distal end of the each of the conducting arms.

7. The LED lamp of claim 6, wherein the distal end of the each of the conducting arms terminates at an inner face of an outmost one of the second fins of the each of the conducting arms, and an outer face of the outmost one of the second fins is flat on which a corresponding LED module is mounted.

8. The LED lamp of claim 1, wherein the lamp base comprises a lamp holder, a first cover connecting with the lamp holder and a second cover facing to and engaging with the first cover.

9. The LED lamp of claim 8, wherein the first and second covers cooperatively form an enclosure enclosing an inner space which communicates with the through hole of the heat sink.

10. The LED lamp of claim 9, wherein the enclosure connects with the lamp holder at one end thereof, forms an annular engaging portion at another end thereof, and defines the vents in a middle thereof, the annular engaging portion threadedly connecting with the heat sink.

11. The LED lamp of claim 10, wherein the heat sink has a fixing part extending downwardly from a bottom of the cylinder thereof, and the fixing part threadedly engages into the engaging portion of the lamp base.

12. An LED lamp comprising:
a lamp base comprising a lamp holder and an enclosure connecting with the lamp holder, the enclosure defining a plurality of vents therein;
a heat sink mounted on the lamp base and comprising a cylinder at a centre thereof and a plurality of second fins surrounding the cylinder, the cylinder having a through hole therein, which communicates with the enclosure, the through hole, the enclosure and the vents cooperatively forming an air circulation passage communicating with ambient air; and
a plurality of LED modules thermally contacting with outmost ones of the second fins of the heat sink, respectively.

13. The heat sink assembly of claim 12, wherein the cylinder has a plurality of first fins extending inwardly from an inner wall thereof.

14. The heat sink assembly of claim 12, wherein a plurality of conducting arms extend outwardly from an outer wall of the cylinder, and the conducting arms are centrosymmetric relative to a central axis of the cylinder.

15. The heat sink assembly of claim 14, wherein the second fins are extended perpendicularly from two lateral sides of the conducting arms.

16. The heat sink assembly of claim 12, wherein the enclosure comprises a first cover connecting with the lamp holder and a second cover facing to and engaging with the first cover.

17. The heat sink assembly of claim 16, wherein the heat sink has a fixing part extending downwardly from a bottom of the cylinder thereof, and the second cover forms an annular engaging portion engaging with the fixing part at a top thereof.

18. An LED lamp comprising:
a base having a lamp holder adapted for connecting with a lamp socket, an inner space and a plurality of vents communicating the inner space with ambient air;
a heat sink mounted on the base, having a cylindrical body defining a hole communicating with the inner space of the base and a plurality of fins surrounding the cylindrical body; and
a plurality of LED modules mounted on outermost ones of the plurality of fins, respectively, and thermally connecting therewith;
wherein when the LED modules are activated, at least a part of heat generated by the LED modules is dissipated to the ambient via air flowing through the hole of the cylindrical body of the heat sink and the inner space of the base.

19. The LED lamp of claim 18, wherein the outermost ones of the plurality of fins have flat outer surfaces, respectively, and the LED modules are mounted on the flat outer surfaces, respectively.

20. The LED lamp of claim 19, wherein the cylindrical body of the heat sink has a plurality of fins extending into the hole.
